(19) United States
(12) Patent Application Publication
(10) Pub. No.: US 2022/0410637 A1
(43) Pub. Date: Dec. 29, 2022

(54) BEAD STRUCTURE FOR A TIRE

(71) Applicant: The Goodyear Tire & Rubber Company, Akron, OH (US)

(72) Inventor: James Christopher Kish, New Franklin, OH (US)

(21) Appl. No.: 17/356,593

(22) Filed: Jun. 24, 2021

(51) Int. Cl. B60C 15/05

(52) U.S. Cl. CPC B60C 15/05; B60C 2015/048

(57) ABSTRACT

A tire includes a carcass ply extending from one bead structure to another bead structure. Each bead structure includes a plurality of circumferentially wound sheath layers surrounding a bead core with a triangular cross-section. The cross-section has two radially inner vertices and a radially outer vertex. The radially outer vertex and one of the radially inner vertices are an angular amount radially offset from a directly radial direction of the tire.

### FIELD OF THE PRESENT INVENTION

The present invention relates to a tire intended to support vehicles and, more specifically, to a bead structure of such a tire.

### BACKGROUND OF THE PRESENT INVENTION

A conventional tire, pneumatic or non-pneumatic, includes a crown part surmounted radially on the outside by a tread intended to come into contact with the roadway, this crown part extending radially inward by sidewalls ending in bead structures. The tire includes a plurality of reinforcement armatures including, in particular, a carcass reinforcement for supporting loads created by the tire internal inflation pressure and the vehicle. This carcass reinforcement extends into the crown and the sidewalls of the tire and is anchored at its ends to appropriate anchoring structures located in the bead structures. A carcass reinforcement may be generally made up of a plurality of reinforcing members arranged parallel to one another and making an angle of, or in the region of, 90 degrees with the circumferential direction (in which case, the carcass reinforcement is said to be “radial”). The carcass reinforcement is usually anchored by turning it up around an anchoring structure of appropriate circumferential rigidity in order to form a turned-up portion of which the length, measured for example with respect to the radially innermost point of the anchoring structure, may be chosen to provide the pneumatic tire with satisfactory durability. Axially between the turned-up portion and the carcass reinforcement may be one or more elastomer-based materials which provide a mechanical coupling between the turned-up portions and the main carcass reinforcement.

In use, the tire may be mounted on a rim with rim seats intended to contact the radially innermost parts of the bead structures. On the axially outer side of each rim seat, a rim flange may fix the axial position of each bead structure when the tire is fitted onto the rim. In order to withstand the mechanical stresses of rotating under load, additional reinforcements may be provided for reinforcing the bead structures. For example, plies may be arranged against at least a part of the turned-up portion of the carcass reinforcement. During use, the bead structures may be subjected to a great many bending cycles, thereby conforming/deforming themselves to the rim flanges (e.g., partially adopting the geometry of the rim flanges). This results in greater or lesser variants in curvature of the bead structures combined with variations in tension in the reinforcement armatures that reinforce the bead structures and, in particular, in the turned-up portion of the carcass reinforcement. These same cycles may induce compressive and tensile loadings in the materials of the bead structures. Also, the reinforcing members of the carcass ply may shift circumferentially and cyclically in the sidewalls and the bead structures of the tire. A cyclic circumferential shift is a shift in one circumferential direction and in the opposite circumferential direction each time the wheel and tire revolve about a position of equilibrium (or no shift).

Stresses and/or deformations may be generated within the materials of the bead structures, and particularly within the elastomeric materials in the immediate vicinity of the ends of the reinforcements (the ends of the turned-up portions of the carcass reinforcement, or ends of the additional reinforcements). These stresses and/or deformations may lead to an appreciable reduction in the operating/service life of the tire.

These stresses and/or deformations may cause delamination and cracking near the ends of the reinforcements and degradation of tire performance. Because of the radial direction of some of the reinforcing members and because of the nature of the reinforcing members (e.g., metal cables), the turned-up ends of the carcass reinforcement may be particularly sensitive to this phenomenon.

### SUMMARY OF THE PRESENT INVENTION

A tire in accordance with the present invention includes a carcass ply extending from one bead structure to another bead structure. Each bead structure includes a plurality of circumferentially wound sheath layers surrounding a bead core with a triangular cross-section. The cross-section has two radially inner vertices and a radially outer vertex. The radially outer vertex and one of the radially inner vertices are an angular amount radially offset from a directly radial direction of the tire.

According to another aspect of the tire, the angular amount is about 0 degrees.

According to still another aspect of the tire, the angular amount is between 5 degrees and 15 degrees.

According to yet another aspect of the tire, the angular amount is about 10 degrees.

According to still another aspect of the tire, the angular amount is between 15 degrees and 25 degrees.

According to yet another aspect of the tire, the angular amount is about 20 degrees.

According to still another aspect of the tire, one of the radially inner vertices has a radius of curvature larger than both a radius of curvature of the other radially inner vertex and a radius of curvature of the radially outer vertex.

According to yet another aspect of the tire, a radius of curvature of the radially outer vertex is larger than radii of curvature of both the radially inner vertices.

According to still another aspect of the tire, one of the radially inner vertices has a radius of curvature between 40% and 60% larger than both a radius of curvature of the other radially inner vertex and a radius of curvature of the radially outer vertex.

According to yet another aspect of the tire, a radius of curvature of the radially outer vertex is between 40% and 60% larger than radii of curvature of both the radially inner vertices.

A tire bead in accordance with the present invention includes a plurality of circumferentially wound sheath layers surrounding a bead core with a triangular cross-section. The cross-section has two radially inner vertices and a radially outer vertex. The radially outer vertex and one of the radially inner vertices are an angular amount radially offset from a directly radial direction of the tire.

According to another aspect of the tire bead, the angular amount is about 0 degrees and one of the radially inner vertices has a radius of curvature larger than both a radius of curvature of the other radially inner vertex and a radius of curvature of the radially outer vertex.

According to still another aspect of the tire bead, the angular amount is between 5 degrees and 15 degrees and a radius of curvature of the radially outer vertex is larger than radii of curvature of both the radially inner vertices.

According to yet another aspect of the tire bead, the angular amount is about 10 degrees and one of the radially inner vertices has a radius of curvature between 40% and 60% larger than both a radius of curvature of the other radially inner vertex and a radius of curvature of the radially outer vertex.

According to still another aspect of the tire bead, the angular amount is between 15 degrees and 25 degrees and a radius of curvature of the radially outer vertex is between 40% and 60% larger than radii of curvature of both the radially inner vertices.

A method forms a tire. The method includes the steps of: extending a carcass ply from one bead structure to another bead structure; circumferentially winding a sheath layer around a bead core with a triangular cross-section; providing the triangular cross-section with two radially inner vertices and a radially outer vertex; and offsetting the radially outer vertex and one of the radially inner vertices by an angular amount from a directly radial direction of the tire.

According to another aspect of the method, the method further includes the steps of offsetting the radially outer vertex and one of the radially inner vertices by an angular amount 0 degrees from a directly radial direction of the tire and enlarging a radius of curvature of one of the radially inner vertices.

According to still another aspect of the method, the method further includes the steps of offsetting the radially outer vertex and one of the radially inner vertices by an angular amount of between 5 degrees and 15 degrees from a directly radial direction of the tire and enlarging a radius of curvature of the radially outer vertex.

According to yet another aspect of the method, the method further includes the steps of offsetting the radially outer vertex and one of the radially inner vertices by an angular amount about 10 degrees from a directly radial direction of the tire and enlarging a radius of curvature of one of the radially inner vertices.

According to still another aspect of the method, the method further includes the steps of offsetting the radially outer vertex and one of the radially inner vertices by an angular between 15 and 25 degrees from a directly radial direction of the tire and enlarging a radius of curvature of the radially outer vertex.

### BRIEF DESCRIPTION OF THE DRAWINGS

Further features and advantages of the present invention will become apparent from the description given hereinafter, with reference to the attached drawings which, by way of non-limiting examples, show some embodiments of the subject matter of the present invention.

FIG. 1 shows a schematic representation of a tire with a bead core structure in accordance with the present invention;

FIG. 2 shows a schematic representation of the bead core of FIG. 1;

FIG. 3 shows a schematic representation of another bead core structure in accordance with the present invention;

FIG. 4 shows a schematic representation of still another bead core structure in accordance with the present invention; and

FIG. 5 shows a schematic representation of yet another bead core structure in accordance with the present invention.

### DEFINITIONS

The following definitions are controlling for the present invention.

“Apex” means an elastomeric filler located radially above the bead core and between the plies and the turnup ply.

“Annular” means formed like a ring.

“Aspect ratio” means the ratio of a tire section height to its section width.

“Aspect ratio of a bead cross-section” means the ratio of a bead section height to its section width.

“Asymmetric tread” means a tread that has a tread pattern not symmetrical about the centerplane or equatorial plane EP of the tire.

“Axial” and “axially” are used herein to refer to lines or directions that are parallel to the axis of rotation of the tire.

“Bead” or “bead portion” means that part of the tire comprising an annular tensile core wrapped by ply cords and shaped, with or without other reinforcement elements such as flippers, chippers, apexes, toe guards and chafers, to fit a design rim. The annular tensile core may be hollow, single-piece, monolithic, and/or of any suitable material, such as metal, ceramic, polymer, carbon, carbon fibers, polyamide, glass, and/or glass fibers.

“Belt structure” means at least two annular layers or plies of parallel cords, woven or unwoven, underlying the tread, unanchored to the bead, and having cords inclined respect to the equatorial plane of the tire. The belt structure may also include plies of parallel cords inclined at relatively low angles, acting as restricting layers.

“Bias tire” (cross ply) means a tire in which the reinforcing cords in the carcass ply extend diagonally across the tire from bead to bead at about a 25° to 65° angle with respect to equatorial plane of the tire. If multiple plies are present, the ply cords run at opposite angles in alternating layers.

“Breakers” means at least two annular layers or plies of parallel reinforcement cords having the same angle with reference to the equatorial plane of the tire as the parallel reinforcing cords in carcass plies. Breakers are usually associated with bias tires.

“Cable” means a cord formed by twisting together two or more plied yarns.

“Carcass” means the tire structure apart from the belt structure, tread, undertread, and sidewall rubber over the plies, but including the beads.

“Casing” means the carcass, belt structure, beads, sidewalls and all other components of the tire excepting the tread and undertread, i.e., the whole tire.

“Chipper” refers to a narrow band of fabric or steel cords located in the bead area whose function is to reinforce the bead area and stabilize the radially inwardmost part of the sidewall.

“Circumferential” means lines or directions extending along the perimeter of the surface of the annular tire parallel to the Equatorial Plane (EP) and perpendicular to the axial direction; it can also refer to the direction of the sets of adjacent circular curves whose radii define the axial curvature of the tread, as viewed in cross section.

“Cord” means one of the reinforcement strands of which the reinforcement structures of the tire are comprised.

“Cord angle” means the acute angle, left or right in a plan view of the tire, formed by a cord with respect to the equatorial plane. The “cord angle” is measured in a cured but uninflated tire.

“Crown” means that portion of the tire within the width limits of the tire tread.

“Denier” means the weight in grams per 9000 meters (unit for expressing linear density). “Dtex” means the weight in grams per 10,000 meters.

“Density” means weight per unit length.

“Elastomer” means a resilient material capable of recovering size and shape after deformation.

“Equatorial plane (EP)” means the plane perpendicular to the tire's axis of rotation and passing through the center of its tread; or the plane containing the circumferential centerline of the tread.

“Fabric” means a network of essentially unidirectionally extending cords, which may be twisted, and which in turn are composed of a plurality of a multiplicity of filaments (which may also be twisted) of a high modulus material.

“Fiber” is a unit of matter, either natural or man-made that forms the basic element of filaments. Characterized by having a length at least 100 times its diameter or width.

“Filament count” means the number of filaments that make up a yarn. Example: 1000 denier polyester has approximately 190 filaments.

“Flipper” refers to a reinforcing fabric around the bead wire for strength and to tie the bead wire in the tire body.

“Footprint” means the contact patch or area of contact of the tire tread with a flat surface at zero speed and under normal load and pressure.

“Gauge” refers generally to a measurement, and specifically to a thickness measurement.

“Groove” means an elongated void area in a tread that may extend circumferentially or laterally about the tread in a straight, curved, or zigzag manner. Circumferentially and laterally extending grooves sometimes have common portions. The “groove width” may be the tread surface occupied by a groove or groove portion divided by the length of such groove or groove portion; thus, the groove width may be its average width over its length. Grooves may be of varying depths in a tire. The depth of a groove may vary around the circumference of the tread, or the depth of one groove may be constant but vary from the depth of another groove in the tire. If such narrow or wide grooves are of substantially reduced depth as compared to wide circumferential grooves, which they interconnect, they may be regarded as forming “tie bars” tending to maintain a rib-like character in the tread region involved. As used herein, a groove is intended to have a width large enough to remain open in the tires contact patch or footprint.

“High Tensile Steel (HT)” means a carbon steel with a tensile strength of at least 3400 MPa at 0.20 mm filament diameter.

“Inner” means toward the inside of the tire and “outer” means toward its exterior.

“Innerliner” means the layer or layers of elastomer or other material that form the inside surface of a tubeless tire and that contain the inflating fluid within the tire.

“Inboard side” means the side of the tire nearest the vehicle when the tire is mounted on a wheel and the wheel is mounted on the vehicle.

“LASE” is load at specified elongation.

“Lateral” means an axial direction.

“Lay length” means the distance at which a twisted filament or strand travels to make a 360 degree rotation about another filament or strand.

“Leaning” means that the radially outer/top vertex is not directly radially outward of the midpoint between the two/lower vertices of a triangular bead core.

“Load Range” means load and inflation limits for a given tire used in a specific type of service as defined by tables in The Tire and Rim Association, Inc.

“Mega Tensile Steel (MT)” means a carbon steel with a tensile strength of at least 4500 MPa at 0.20 mm filament diameter.

“Net contact area” means the total area of ground contacting elements between defined boundary edges divided by the gross area between the boundary edges as measured around the entire circumference of the tread.

“Net-to-gross ratio” means the total area of ground contacting tread elements between lateral edges of the tread around the entire circumference of the tread divided by the gross area of the entire circumference of the tread between the lateral edges.

“Non-directional tread” means a tread that has no preferred direction of forward travel and is not required to be positioned on a vehicle in a specific wheel position or positions to ensure that the tread pattern is aligned with the preferred direction of travel. Conversely, a directional tread pattern has a preferred direction of travel requiring specific wheel positioning.

“Normal Load” means the specific design inflation pressure and load assigned by the appropriate standards organization for the service condition for the tire.

“Normal Tensile Steel (NT)” means a carbon steel with a tensile strength of at least 2800 MPa at 0.20 mm filament diameter.

“Outboard side” means the side of the tire farthest away from the vehicle when the tire is mounted on a wheel and the wheel is mounted on the vehicle.

“Ply” means a cord-reinforced layer of rubber-coated radially deployed or otherwise parallel cords.

“Radial” and “radially” are used to mean directions radially toward or away from the axis of rotation of the tire.

“Radial Ply Structure” means the one or more carcass plies or which at least one ply has reinforcing cords oriented at an angle of between 65° and 90° with respect to the equatorial plane of the tire.

“Radial Ply Tire” means a belted or circumferentially-restricted pneumatic tire in which at least one ply has cords which extend from bead to bead are laid at cord angles between 65° and 90° with respect to the equatorial plane of the tire.

“Rib” means a circumferentially extending strip of rubber on the tread which is defined by at least one circumferential groove and either a second such groove or a lateral edge, the strip being laterally undivided by full-depth grooves.

“Rivet” means an open space between cords in a layer.

“Section Height” means the radial distance from the nominal rim diameter to the outer diameter of the tire at its equatorial plane.

“Section Width” means the maximum linear distance parallel to the axis of the tire and between the exterior of its sidewalls when and after it has been inflated at normal pressure for 24 hours, but unloaded, excluding elevations of the sidewalls due to labeling, decoration or protective bands.

“Self-supporting run-flat” means a type of tire that has a structure wherein the tire structure alone is sufficiently strong to support the vehicle load when the tire is operated in the uninflated condition for limited periods of time and limited speed. The sidewall and internal surfaces of the tire may not collapse or buckle onto themselves due to the tire structure alone (e.g., no internal structures).

“Sidewall insert” means elastomer or cord reinforcements located in the sidewall region of a tire. The insert may be an addition to the carcass reinforcing ply and outer sidewall rubber that forms the outer surface of the tire.

“Sidewall” means that portion of a tire between the tread and the bead.

“Sipe” or “incision” means small slots molded into the tread elements of the tire that subdivide the tread surface and improve traction; sipes may be designed to close when within the contact patch or footprint, as distinguished from grooves.

“Spring Rate” means the stiffness of tire expressed as the slope of the load deflection curve at a given pressure.

“Stiffness ratio” means the value of a control belt structure stiffness divided by the value of another belt structure stiffness when the values are determined by a fixed three point bending test having both ends of the cord supported and flexed by a load centered between the fixed ends.

“Super Tensile Steel (ST)” means a carbon steel with a tensile strength of at least 3650 MPa at 0.20 mm filament diameter.

“Tenacity” is stress expressed as force per unit linear density of the unstrained specimen (gm/tex or gm/denier). Used in textiles.

“Tensile” is stress expressed in forces/cross-sectional area. Strength in psi=12,800 times specific gravity times tenacity in grams per denier.

“Toeguard” refers to the circumferentially deployed elastomeric rim-contacting portion of the tire axially inward of each bead.

“Tread” means a molded rubber component which, when bonded to a tire casing, includes that portion of the tire that comes into contact with the road when the tire is normally inflated and under normal load.

“Tread element” or “traction element” means a rib or a block element.

“Tread width” means the arc length of the tread surface in a plane including the axis of rotation of the tire.

“Turnup end” means the portion of a carcass ply that turns upward (i.e., radially outward) from the beads about which the ply is wrapped.

“Ultra Tensile Steel (UT)” means a carbon steel with a tensile strength of at least 4000 MPa at 0.20 mm filament diameter.

“Vertical Deflection” means the amount that a tire deflects under load.

“Yarn” is a generic term for a continuous strand of textile fibers or filaments. Yarn occurs in the following forms: (1) a number of fibers twisted together; (2) a number of filaments laid together without twist; (3) a number of filaments laid together with a degree of twist; (4) a single filament with or without twist (monofilament); and (5) a narrow strip of material with or without twist.

### DESCRIPTION OF EXAMPLE EMBODIMENTS OF THE PRESENT INVENTION

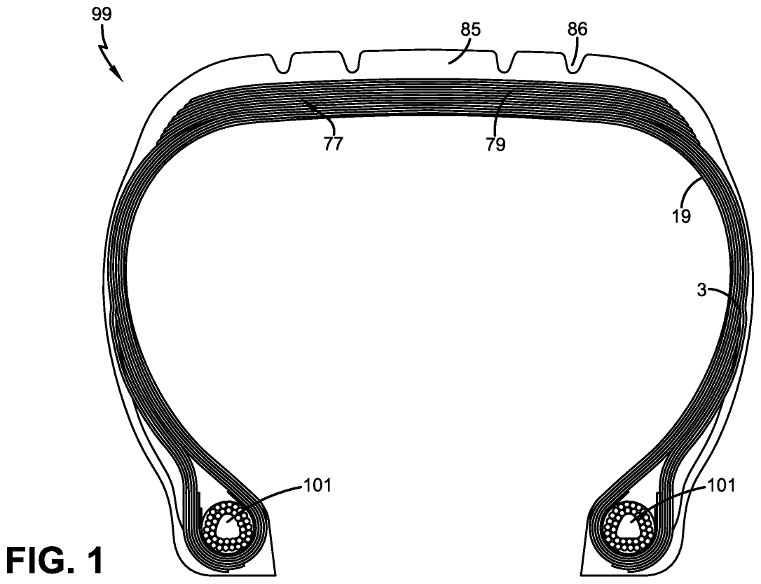

With reference to FIG. 1, an example tire 99 for use with the present invention may have an air impervious inner liner 19, at least two axially inner plies, as shown three of these plies 3 extending across the crown region of the tire 99 into the bead area 101 and wrap about the bead cores extending to terminal ends. These terminal ends may be covered by axially outer plies, which extend from bead to bead to ends that lie under the bead core 82.

The entire cross section of the tire 99 is shown in FIG. 1. The crown reinforcement 77 may be formed of several belt layers 79 and have an axial maximum belt width as measured between the maximum width belt edges of the crown reinforcement 77. The crown reinforcement 77 may have cords aligned at an angle between 0 and 45 degrees relative to the circumferential direction of the tire 99. Radially outward of the crown reinforcement 77 may be a rubber tread 85 having a plurality of circumferential grooves 86 for water drainage.

Conventional radial aircraft tires may have cable beads. The predominant shape of available bead cores is typically circular. A metal or polymer rod may be bent/molded into a circle and welded/fused to form a hoop. Recent manufacturing advances have provided new techniques for forming a bead core, such as 3D printing, molding of composites, etc. This may allow bead shape to be designed without the limitations of many industry standards. A semi-triangular shape for a bead core, in accordance with the present invention, may provide a more stable fitment between tire and rim (e.g., greater ply durability, less rim slip, etc.). Circular beads interact with the rim at a point type of contact (round dowel surface on flat surface).

However, one flat side of a semi-triangular bead may be parallel to rotation of the wheel and create more widely distributed stresses (flat surface on flat surface). As a result, a semi-triangular bead may anchor the tire plies more securely to the rim. Clamping the ply more like two faces of bench vise, over life of tire, may mitigate or prevent motion of the bead relative to the rim and thereby prevent plies nearest the bead from over working, possibly separating, and/or eventually breaking. Depending on the material type chosen, reduction in weight of the bead structure and the overall tire may be achieved.

The radially outer top of the semi-triangular shape may thus be wider at the bottom than at the top. The top of the triangular shape may also be directly axially centered over the base of the bead structure or may be axially offset (e.g., a leaning triangle; FIG. 5). A leaning triangular bead shape may thereby coincide with a natural ply line of a lower sidewall of tire. The corners of a semi-triangular bead core may also have radii, as well.

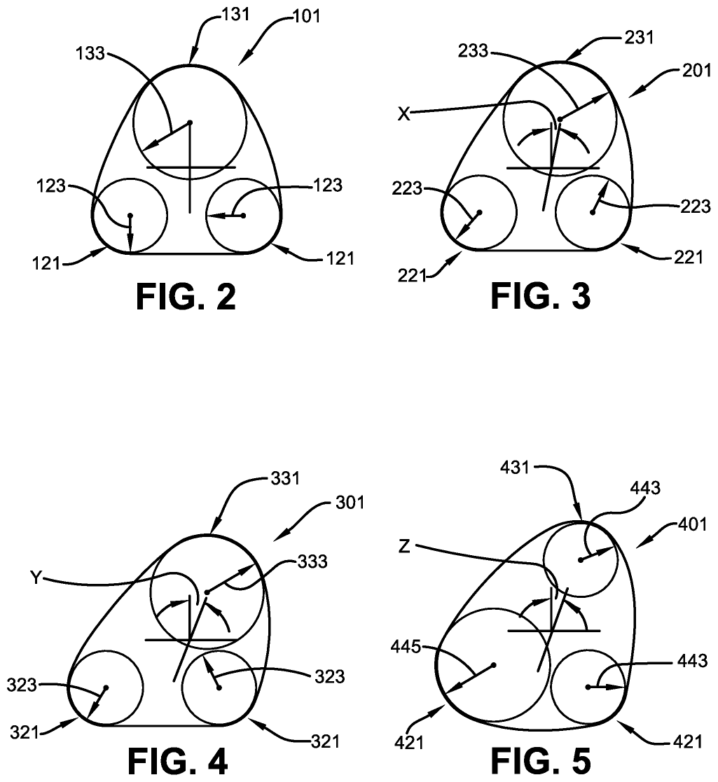

In accordance with the present invention, FIGS. 1 and 2 schematically show an isosceles semi-triangular bead core 101 with the two radially inner vertices 121 having a common bottom radius 123 and the radially outer/top vertex 131 having a larger top radius 133. The larger top radius 133 may be between 40% and 60%, or 50% larger than the bottom radii 123. The radially outer/top vertex 131 may be 0 degrees radially offset from, or coincident with, the radial direction.

In accordance with the present invention, FIG. 3 schematically shows a “leaning” semi-triangular bead core 201 with the two radially inner vertices 221 having common bottom radii 223 and a radially outer/top vertex 231 having a larger top radius 133 and offset axially directly outward by X degrees. The larger top radius 233 may be between 40% and 60%, or 50% larger than the bottom radii 223. X may be between 5 degrees and 15 degrees, or about 10 degrees. A non-zero degree offset may require specific staging procedures of beads during tire manufacturing.

In accordance with the present invention, FIG. 4 schematically shows a “leaning” semi-triangular bead core 301 with the two radially inner vertices 321 having common bottom radii 323 and a radially outer/top vertex 331 having a larger top radius 333 and offset axially directly outward by Y degrees. The larger top radius 333 may be between 40% and 60%, or 50% larger than the bottom radii 323. Y may be between 15 degrees and 25 degrees, or about 20 degrees. A non-zero degree offset may require specific staging procedures of beads during tire manufacturing.

In accordance with the present invention, FIG. 5 schematically shows a “leaning” semi-triangular bead core 401 with one of the two radially inner vertices 421 (e.g., the heel radius, etc.) and a radially outer/top vertex 431 having common radii 443 and the other of the two radially inner vertices 421 (e.g., the toe vertex, etc.) having a larger radius 435 between 40% and 60%, or 50% larger than the common radii 343. The radially outer/top vertex 431 may be offset to axially directly outward by Z degrees. Z may be between 15 degrees and 25 degrees, or about 20 degrees. A non-zero degree offset may require specific staging procedures of beads during tire manufacturing.

Variations in the present invention are possible in light of the description of it provided herein. While certain representative examples and details have been shown for the purpose of illustrating the present invention, it will be apparent to those skilled in this art that various changes and modifications may be made therein without departing from the scope of the present invention. It is, therefore, to be understood that changes may be made in the particular examples described which will be within the full intended scope of the present invention as defined by the following appended claims.

The present invention claimed:

1. A tire comprising:
a carcass ply extending from one bead structure to another bead structure, each bead structure comprising a plurality of circumferentially wound sheath layers surrounding a bead core with a triangular cross-section, the cross-section having two radially inner vertices and a radially outer vertex, the radially outer vertex and one of the radially inner vertices being an angular amount radially offset from a directly radial direction of the tire.

2. The tire as set forth in claim 1 wherein the angular amount is about 0 degrees.

3. The tire as set forth in claim 1 wherein the angular amount is between 5 degrees and 15 degrees.

4. The tire as set forth in claim 1 wherein the angular amount is about 10 degrees.

5. The tire as set forth in claim 1 wherein the angular amount is between 15 degrees and 25 degrees.

6. The tire as set forth in claim 1 wherein the angular amount is about 20 degrees.

7. The tire as set forth in claim 1 wherein one of the radially inner vertices has a radius of curvature larger than both a radius of curvature of the other radially inner vertex and a radius of curvature of the radially outer vertex.

8. The tire as set forth in claim 1 wherein a radius of curvature of the radially outer vertex is larger than radii of curvature of both the radially inner vertices.

9. The tire as set forth in claim 1 wherein one of the radially inner vertices has a radius of curvature between 40% and 60% larger than both a radius of curvature of the other radially inner vertex and a radius of curvature of the radially outer vertex.

10. The tire as set forth in claim 1 wherein a radius of curvature of the radially outer vertex is between 40% and 60% larger than radii of curvature of both the radially inner vertices.

11. A tire bead comprising:
a plurality of circumferentially wound sheath layers surrounding a bead core with a triangular cross-section, the cross-section having two radially inner vertices and a radially outer vertex, the radially outer vertex and one of the radially inner vertices being an angular amount radially offset from a directly radial direction of the tire.

12. The tire as set forth in claim 11 wherein the angular amount is about 0 degrees and one of the radially inner vertices has a radius of curvature larger than both a radius of curvature of the other radially inner vertex and a radius of curvature of the radially outer vertex.

13. The tire as set forth in claim 11 wherein the angular amount is between 5 degrees and 15 degrees and a radius of curvature of the radially outer vertex is larger than radii of curvature of both the radially inner vertices.

14. The tire as set forth in claim 11 wherein the angular amount is about 10 degrees and one of the radially inner vertices has a radius of curvature between 40% and 60% larger than both a radius of curvature of the other radially inner vertex and a radius of curvature of the radially outer vertex.

15. The tire as set forth in claim 11 wherein the angular amount is between 15 degrees and 25 degrees and a radius of curvature of the radially outer vertex is between 40% and 60% larger than radii of curvature of both the radially inner vertices.

16. A method of forming a tire, the method including the steps of:
extending a carcass ply from one bead structure to another bead structure;
circumferentially winding a sheath layer around a bead core with a triangular cross-section;
providing the triangular cross-section with two radially inner vertices and a radially outer vertex; and
offsetting the radially outer vertex and one of the radially inner vertices by an angular amount from a directly radial direction of the tire.

17. The method as set forth in claim 16 further including the steps of offsetting the radially outer vertex and one of the radially inner vertices by an angular amount 0 degrees from a directly radial direction of the tire and enlarging a radius of curvature of one of the radially inner vertices.

18. The method as set forth in claim 16 further including the steps of offsetting the radially outer vertex and one of the radially inner vertices by an angular amount of between 5 degrees and 15 degrees from a directly radial direction of the tire and enlarging a radius of curvature of the radially outer vertex.

19. The method as set forth in claim 16 further including the steps of offsetting the radially outer vertex and one of the radially inner vertices by an angular amount about 10 degrees from a directly radial direction of the tire and enlarging a radius of curvature of one of the radially inner vertices.

20. The method as set forth in claim 16 further including the steps of offsetting the radially outer vertex and one of the radially inner vertices by an angular between 15 and 25 degrees from a directly radial direction of the tire and enlarging a radius of curvature of the radially outer vertex.
